(19) United States
(12) Patent Application Publication
(10) Pub. No.: US 2010/0321440 A1
(43) Pub. Date: Dec. 23, 2010

(54) INKJET HEAD MAINTENANCE METHOD

(75) Inventor: Xiang-Qing Ye, Taipei (TW)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 12/543,142

(22) Filed: Aug. 18, 2009

(30) Foreign Application Priority Data
Jun. 19, 2009 (TW) 098120553

(51) Int. Cl. B41J 29/393

(52) U.S. Cl. 347/19

(57) ABSTRACT

An inkjet head maintenance method is used in an inkjet printing apparatus, the inkjet printing apparatus includes a control unit, an inkjet head maintenance unit and at least one inkjet head. Firstly, the control unit reads inkjet head maintenance data from a predetermined inkjet head maintenance table. The inkjet head maintenance table includes the inkjet head maintenance data correlating with different printing modes. The inkjet head maintenance data include the number of maintenance times of the inkjet head during a predetermined printing period or a time interval between two adjacent maintenance times of the inkjet head. Next, the control unit issues an inkjet head maintenance command to the inkjet head maintenance unit according to the read inkjet head maintenance data. In response to the inkjet head maintenance command, the inkjet head maintenance unit is controlled to perform an inkjet head maintenance task corresponding to the inkjet head maintenance data.

### FIELD OF THE INVENTION

The present invention relates to an inkjet head maintenance method, and more particularly to an inkjet head maintenance method for use in an inkjet printing apparatus.

### BACKGROUND OF THE INVENTION

With increasing development of personal computers, inkjet printers are widely used as peripheral devices of personal computers. Conventionally, the inkjet printer has a single-color ink cartridge (e.g. a black ink cartridge) and an inkjet head for performing a single-color printing operation. Recently, a color printer has CMYK (cyan, magenta, yellow, and black) ink cartridges and an inkjet head assembly for performing a multi-color printing operation. It is of course that the color printer could also print out black images. In other words, inkjet printers could be used to implement two kinds of printing tasks. The first kind of printing task is implemented to print out black images or texts. The second kind of printing task is implemented to print out colorful pictures or texts. For preventing nozzle clogging of the inkjet head, an inkjet head maintenance method is periodically performed. By the inkjet head maintenance method, the ink contained in all ink cartridges needs to be printed out for one or several times. As known, since some of the color ink cartridges are not frequently used, the inkjet head maintenance method usually wastes the ink contained in such color ink cartridges.

Conventionally, according to the setting of a printing program installed in the inkjet printer, the inkjet printer is normally operated when all color ink cartridges are mounted on the inkjet printer. In other words, the color ink cartridges that are not frequently used should also be mounted on the inkjet printer. Since the inkjet head maintenance process is periodically performed, the ink contained in all ink cartridges needs to be printed out during the inkjet head maintenance method. As known, it is not environmentally friendly to periodically print out the ink that is not frequently used.

### SUMMARY OF THE INVENTION

It is an object of the present invention to provide an inkjet head maintenance method for reducing ink consumption.

In accordance with an aspect of the present invention, there is provided an inkjet head maintenance method for use in an inkjet printing apparatus, the inkjet printing apparatus includes a control unit, an inkjet head maintenance unit and at least one inkjet head. Firstly, the control unit reads inkjet head maintenance data from a predetermined inkjet head maintenance table. The inkjet head maintenance table includes the inkjet head maintenance data correlating with different printing modes. The inkjet head maintenance data include the number of maintenance times of the inkjet head during a predetermined printing period or a time interval between two adjacent maintenance times of the inkjet head. Next, the control unit issues an inkjet head maintenance command to the inkjet head maintenance unit according to the read inkjet head maintenance data. In response to the inkjet head maintenance command, the inkjet head maintenance unit is controlled to perform an inkjet head maintenance task corresponding to the inkjet head maintenance data.

In an embodiment, the printing modes are expressed by printing quality levels.

In an embodiment, the inkjet printing apparatus includes at least one multi-color inkjet head assembly, and the multi-color inkjet head assembly includes inkjet heads corresponding to respective primary colors.

In an embodiment, the inkjet printing apparatus further includes a single-color inkjet head for performing a single-color printing operation. The multi-color inkjet head assembly is used for performing a multi-color printing operation. The printing modes are also expressed by printing color types, and the printing color types are classified into a single-color type and a multi-color type.

In an embodiment, if the printing color type is a single-color type and a single-color printing operation is performed, the number of maintenance times for the single-color inkjet head during the predetermined printing period is dependent on the printing quality levels shown in the inkjet head maintenance table, and the number of maintenance times for the multi-color inkjet head assembly during the predetermined printing period is the minimum or equal to zero. Whereas, if the printing color type is a multi-color type and a multi-color printing operation is performed, the number of maintenance times for the multi-color inkjet head assembly during the predetermined printing period is dependent on the printing quality levels, and the number of maintenance times for the single-color inkjet head during the predetermined printing period is the minimum or equal to zero.

In an embodiment, the printing quality levels are classified into a best printing quality level, a better printing quality level, a normal printing quality level, and a draft printing quality level, which are arranged in a descending order. If the printing color type is a single-color type, the number of maintenance times for the single-color inkjet head during the predetermined printing period is reduced as the printing quality level is decreased. Whereas, if the printing color type is a multi-color type, the number of maintenance times for the multi-color inkjet head assembly during the predetermined printing period is reduced as the printing quality level is decreased.

In an embodiment, the primary colors include a cyan color, a magenta color, a yellow color and a black color.

In an embodiment, the printing modes are further expressed by main printing color types when a multi-color printing operation is performed. The main printing color types include frequently-used primary colors in the multi-color printing operation. The inkjet head maintenance unit reduces the number of maintenance times of the inkjet heads corresponding to other primary colors during the predetermined printing period in comparison with the frequently-used primary colors.

In an embodiment, the inkjet printing apparatus only includes a single-color inkjet head.

In an embodiment, before the inkjet head maintenance data are read by the control unit, the control unit discriminates whether a signal relating to a printing maintenance status of the inkjet printing apparatus is received.

In an embodiment, before the control unit discriminates whether the signal relating to the printing maintenance status of the inkjet printing apparatus is received, the control unit discriminates whether a printing command of the inkjet printing apparatus is received.

In an embodiment, the inkjet printing apparatus is an inkjet printer.

In an embodiment, the inkjet printing apparatus is a multifunction peripheral.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a flowchart illustrating an inkjet head maintenance method according to an embodiment of the present invention.

### DETAILED DESCRIPTION OF THE PREFERRED EMBODIMENT

The present invention provides an inkjet head maintenance method for use in an inkjet printing apparatus. An example of the inkjet printing apparatus includes but is not limited to an inkjet printer, a multifunction peripheral (MFP) or the like. The present invention will be illustrated by referring an inkjet printer as the inkjet printing apparatus. The inkjet printing apparatus comprises a control unit, an inkjet head maintenance unit, at least one single-color inkjet head and at least one multi-color inkjet head assembly. The single-color inkjet head and the multi-color inkjet head assembly are used for performing a single-color (black) printing operation and a multi-color printing operation, respectively. An example of the multi-color inkjet head assembly includes a four-color inkjet head assembly or a six-color inkjet head assembly. The four-color inkjet head assembly includes four inkjet heads of respective primary colors CMYK (cyan, magenta, yellow, and black). The six-color inkjet head assembly includes six inkjet heads of respective primary colors.

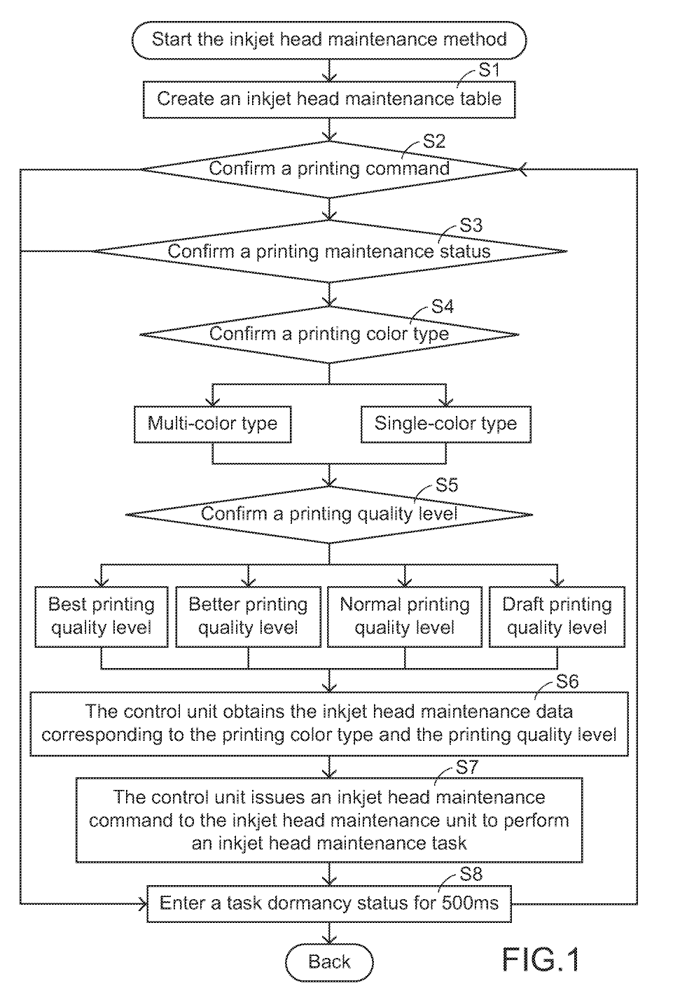

FIG. 1 is a flowchart illustrating an inkjet head maintenance method according to an embodiment of the present invention. After the inkjet head maintenance method is activated, an inkjet head maintenance table as shown in Table 1 is created (Step S1). The inkjet head maintenance table includes the inkjet head maintenance data correlating with different printing modes. The printing modes are expressed by the printing color types and the printing quality levels. For example, the printing color types are classified into a single-color type and a multi-color type. The printing quality levels are classified into a best printing quality level, a better printing quality level, a normal printing quality level, and a draft printing quality level, which are arranged in a descending order. The inkjet head maintenance data include the number of maintenance times during a predetermined printing period, i.e. the number of maintenance times for ejecting ink by all nozzles of the inkjet head during the predetermined printing period.

TABLE 1
inkjet head maintenance table

| | | Number of | Number of |
|---|---|---|---|
| Printing | | maintenance times for | maintenance times for |
| color | Printing | single-color inkjet head | multi-color inkjet head |
| type | quality | during a printing period | during a printing period |
| Single- | Best | N + 1 | N-c or 0 |
| color | Better | N-a | N-c or 0 |
| | Normal | N-b | N-c or 0 |
| | Draft | N-c | N-c or 0 |
| Multi- | Best | N-c or 0 | N + 1 |
| color | Better | N-c or 0 | N-a |
| | Normal | N-c or 0 | N-b |
| | Draft | N-c or 0 | N-c |

In this embodiment, the inkjet head maintenance data include the single-color inkjet head maintenance data and the multi-color inkjet head maintenance data. In this embodiment, the inkjet heads of the multi-color inkjet head assembly corresponding to respective primary colors have the same number of maintenance times during the predetermined printing period. As shown in Table 1, the number of maintenance times for the multi-color inkjet head during a printing period indicates the number of maintenance times for each of the inkjet heads corresponding to respective primary colors. As shown in Table 1, the number of maintenance times for the single-color inkjet head and the number of maintenance times for the multi-color inkjet head are empirical values. That is, the values N+1, N-a, N-b, N-c are empirical values. There empirical values could be adjusted according to the practical requirements. Moreover, 1<a<b<c. In a case that the printing color type is a single-color type, the number of maintenance times for the single-color inkjet head during the predetermined printing period is reduced as the printing quality level is decreased. The number of maintenance times for the multi-color inkjet head assembly during the predetermined printing period is the same as that for the single-color inkjet head at the draft printing quality level. That is, the number of maintenance times for the multi-color inkjet head assembly during the predetermined printing period is the minimum or equal to zero (i.e. no maintenance).

In a case that the printing color type is a multi-color type, the number of maintenance times for the multi-color inkjet head during the predetermined printing period is reduced as the printing quality level is decreased. The number of maintenance times for the single-color inkjet head during the predetermined printing period is the same as that for the multi-color inkjet head assembly at the draft printing quality level. That is, the number of maintenance times for the single-color inkjet head during the predetermined printing period is the minimum or equal to zero (i.e. no maintenance).

In the above embodiment, the inkjet head maintenance data are illustrated by referring to the number of maintenance times during the predetermined printing period. Nevertheless, the inkjet head maintenance data could be expressed by a time interval between two adjacent maintenance times of the inkjet head.

After the inkjet head maintenance table is created (Step S1), a printing command is confirmed (Step S2). If the control unit discriminates that the printing command of the inkjet printer is received, the printing maintenance status is confirmed (Step S3). If the control unit discriminates that a signal relating to the printing maintenance status of the inkjet printer is received, the inkjet head maintenance method enters the Step S4, or otherwise enters the Step S8.

In the Step S4, the printing color type is confirmed. The printing color type could be selected by the user or automatically determined according to the image information by the printing system. The printing color type includes a multi-color type or a single-color type. After the printing color type is selected, the printing quality level is confirmed (Step S5). The printing quality levels are classified into a best printing quality level, a better printing quality level, a normal printing quality level, and a draft printing quality level. The printing quality level is selected by the user according to the practical requirements.

After the printing color type and the printing quality level are selected, the inkjet head maintenance data corresponding to the printing color type and the printing quality level are obtained (Step S6). In the Step S6, the inkjet head maintenance data are read out from the predetermined inkjet head maintenance table by the control unit of the inkjet printing apparatus according to the printing mode determined in the Step S3 and the Step S4.

Next, the control unit issues an inkjet head maintenance command to the inkjet head maintenance unit according to the read inkjet head maintenance data, and the inkjet head maintenance unit is controlled to perform an inkjet head maintenance task corresponding to the inkjet head maintenance data (Step S7).

Next, the inkjet printing apparatus enters a task dormancy status (Step S8). After the duration of the task dormancy status exceeds 500 ms, the above procedures will be repeatedly done.

It is noted that the Step S4 and the Step S5 of the inkjet head maintenance method could be exchanged.

Since the inkjet head maintenance method of the present invention adjusts the number of maintenance times according to the printing color type and the printing quality level, the number of maintenance times of the inkjet head corresponding to the ink that is not frequently used will be reduced. Under this circumstance, the consumption of the ink that is not frequently used is reduced and thus the purpose of saving ink is achieved.

The inkjet head maintenance method of the present invention could be applied to a multi-color inkjet printing apparatus that only has CMYK (cyan, magenta, yellow, and black) ink cartridges. That is, the inkjet printing apparatus only has a multi-color inkjet head assembly. According to the inkjet head maintenance table as shown in Table 1, the inkjet head maintenance tasks corresponding to the multi-color type and different printing quality levels are performed.

The inkjet head maintenance method of the present invention could be applied to an inkjet printing apparatus that a single-color ink cartridge. That is, the inkjet printing apparatus only has a single-color inkjet head. According to the inkjet head maintenance table as shown in Table 1, the inkjet head maintenance tasks corresponding to different printing quality levels are performed.

In the above embodiments, the printing quality levels are classified into four different levels. Nevertheless, the printing quality levels could be classified into two, three or more than four levels.

In some embodiments of the inkjet head maintenance method, the printing modes are also expressed by the main printing color types when the multi-color printing operation is performed. The main printing color types include the frequently-used primary colors in the multi-color printing operation. The main printing color types are selected by the user or automatically determined according to the image information by the printing system. By the inkjet head maintenance unit, the number of maintenance times of the inkjet heads corresponding to other primary colors during the predetermined printing period will be reduced in comparison with the frequently-used primary colors. For example, if the cyan color and the magenta color belong to the main printing color types, the number of maintenance times of the inkjet heads corresponding to the yellow color and the black color during the predetermined printing period could be reduced. Since the consumption of the ink that is not frequently used is reduced, the purpose of saving ink is achieved.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An inkjet head maintenance method for use in an inkjet printing apparatus, said inkjet printing apparatus comprising a control unit, an inkjet head maintenance unit and at least one inkjet head, said inkjet head maintenance method comprising steps of:
(1) allowing said control unit to read inkjet head maintenance data from a predetermined inkjet head maintenance table, wherein said inkjet head maintenance table includes said inkjet head maintenance data correlating with different printing modes, and said inkjet head maintenance data include the number of maintenance times of said inkjet head during a predetermined printing period or a time interval between two adjacent maintenance times of said inkjet head; and
(2) allowing said control unit to issue an inkjet head maintenance command to said inkjet head maintenance unit according to said read inkjet head maintenance data, wherein in response to said inkjet head maintenance command, said inkjet head maintenance unit is controlled to perform an inkjet head maintenance task corresponding to said inkjet head maintenance data.

2. The inkjet head maintenance method according to claim 1 wherein said printing modes are expressed by printing quality levels.

3. The inkjet head maintenance method according to claim 2 wherein said inkjet printing apparatus comprises at least one multi-color inkjet head assembly, and said multi-color inkjet head assembly comprises inkjet heads corresponding to respective primary colors.

4. The inkjet head maintenance method according to claim 3 wherein said inkjet printing apparatus further comprises a single-color inkjet head for performing a single-color printing operation, and said multi-color inkjet head assembly is used for performing a multi-color printing operation, wherein said printing modes are also expressed by printing color types, and said printing color types are classified into a single-color type and a multi-color type.

5. The inkjet head maintenance method according to claim 4 wherein if said printing color type is a single-color type and a single-color printing operation is performed, the number of maintenance times for said single-color inkjet head during the predetermined printing period is dependent on said printing quality levels shown in said inkjet head maintenance table, and the number of maintenance times for said multi-color inkjet head assembly during said predetermined printing period is the minimum or equal to zero, wherein if said printing color type is a multi-color type and a multi-color printing operation is performed, the number of maintenance times for said multi-color inkjet head assembly during the predetermined printing period is dependent on said printing quality levels, and the number of maintenance times for said single-color inkjet head during said predetermined printing period is the minimum or equal to zero.

6. The inkjet head maintenance method according to claim 5 wherein said printing quality levels are classified into a best printing quality level, a better printing quality level, a normal printing quality level, and a draft printing quality level, which are arranged in a descending order, wherein if said printing color type is a single-color type, the number of maintenance times for said single-color inkjet head during said predetermined printing period is reduced as said printing quality level is decreased, and if said printing color type is a multi-color type, the number of maintenance times for said multi-color inkjet head assembly during said predetermined printing period is reduced as said printing quality level is decreased.

7. The inkjet head maintenance method according to claim 3 wherein said primary colors include a cyan color, a magenta color, a yellow color and a black color.

8. The inkjet head maintenance method according to claim 3 wherein said printing modes are further expressed by main printing color types when a multi-color printing operation is performed, said main printing color types include frequently-used primary colors in said multi-color printing operation, and said inkjet head maintenance unit reduces the number of maintenance times of said inkjet heads corresponding to other primary colors during the predetermined printing period in comparison with said frequently-used primary colors.

9. The inkjet head maintenance method according to claim 1 wherein said inkjet printing apparatus only comprises a single-color inkjet head.

10. The inkjet head maintenance method according to claim 1 wherein before said inkjet head maintenance data are read by said control unit, said control unit discriminates whether a signal relating to a printing maintenance status of said inkjet printing apparatus is received.

11. The inkjet head maintenance method according to claim 10 wherein before said control unit discriminates whether said signal relating to said printing maintenance status of said inkjet printing apparatus is received, said control unit discriminates whether a printing command of said inkjet printing apparatus is received.

12. The inkjet head maintenance method according to claim 1 wherein said inkjet printing apparatus is an inkjet printer.

13. The inkjet head maintenance method according to claim 1 wherein said inkjet printing apparatus is a multifunction peripheral.
